(19) United States
(12) Patent Application Publication
(10) Pub. No.: US 2006/0191957 A1
(43) Pub. Date: Aug. 31, 2006

(54) Glue dispensing apparatus

(75) Inventors: Grigore Axinte, Kent, WA (US); Russell Borgmann, Bellevue, WA (US); John Lu, Renton, WA (US); Stephen Klein, Bothell, WA (US); Amanda Wu, Seattle, WA (US)

Correspondence Address: WILMER CUTLER PICKERING HALE AND DORR LLP, 1875 PENNSYLVANIA AVE., NW, WASHINGTON, DC, 20004, US

(73) Assignee: Hyperion Innovations Inc., Bellevue, WA (US)

(21) Appl. No.: 11/188,649

(22) Filed: Jul. 26, 2005

Related U.S. Application Data
(60) Provisional application No. 60/629,330, filed on Nov. 18, 2004.
(60) Provisional application No. 60/618,941, filed on Oct. 13, 2004.

(51) Int. Cl. B67D 5/62

(52) U.S. Cl. 222/146.5

(57) ABSTRACT

Technology is disclosed for enabling power-efficient and safe use of a portable electronic apparatus such as a glue gun. The tool is designed so as to allow for cordless operation, and the sizing, shape and composition of the heater and the motion sensing, temperature sensing and timing circuitry that are incorporated into the device maximize the amount of heat output to thereby minimize the energy required for powering the tool.

This application claims the benefit of U.S. Provisional Patent Nos. 60/618,941, filed Oct. 13, 2004, and 60/629,330, filed Nov. 18, 2004. The disclosures of all related applications cited above are hereby incorporated by reference.

### FIELD OF THE INVENTION

The present invention relates to portable electronic devices, and more particularly, to portable electronic devices that eject liquefied adhesive, such as glue guns.

### BACKGROUND OF THE INVENTION

Glue guns dispense melted glue to provide adhesive for affixing materials or objects to each other. A glue gun is an important tool that hobbyists, craftsman, and other project enthusiasts use for certain projects when accurate placement of adhesive is required.

Glue guns typically include a barrel member with an internal melting chamber and an electrical heating element used for heating the chamber. The internal melting chamber is made of a thermally conductive material, such as aluminum. This is shaped to receive a glue stick, which is a solidified supply of adhesive (and, in its solid form, looks much like a small candle). The heating element generates heat from electrical energy flowing through it, which heats the melting chamber to melt the end portion of the glue stick therein.

To operate most conventional glue guns, a user first inserts a glue stick and plugs an electrical cord from the tool into an AC electrical outlet to supply electricity and begin heating the melting chamber. After a few minutes of heating, the glue gun will have melted at least part of the glue stick and is ready for use. Once the glue gun is ready, a user grips the tool by a handle with one hand, positions it while maintaining the plug in the electrical outlet and maneuvering the corresponding electrical cord, and presses a trigger on the handle to force molten adhesive material out of the melting chamber through a nozzle at the end of the barrel. As long as the tool is plugged in, the barrel stays hot and will continue to dispense molten adhesive upon depressing the trigger.

### SUMMARY

An apparatus for dispensing liquefied adhesive is disclosed. The apparatus includes a chamber having an opening at one end thereof for allowing a supply of solidified adhesive to be inserted therein. A nozzle fluidly communicates with the chamber, configured for allowing molten adhesive to flow therethrough. A heater is associated with the chamber and operable to apply heat to the chamber sufficient to melt a portion of a solidified adhesive inserted in the chamber. The heater is comprised of a semiconductive material configured to substantially surround a circumference of a longitudinal portion of the chamber.

An apparatus for dispensing liquefied adhesive is also disclosed that is capable of cordless operation. The apparatus also includes a chamber having an opening at one end thereof for allowing a supply of solidified adhesive to be inserted therein, a nozzle fluidly communicated with the chamber, configured for allowing molten adhesive to flow therethrough, and a heater associated with the chamber and operable to apply heat to the chamber sufficient to melt a portion of a solidified adhesive inserted in the chamber. The apparatus further includes a power source in electrical communication with the heater that is capable of providing for cordless operation. A temperature sensor is also included for detecting the temperature of the chamber, wherein output of the sensor is provided as an input to circuitry that that turns off electrical power to the heater when the temperature of the chamber reaches a threshold amount.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a side cross-sectional view of one exemplary embodiment of a liquid dispensing apparatus constructed in accordance with aspects of the present invention;

FIG. 2A is a magnified exterior view of a heater assembly that may be utilized in an exemplary embodiment of a liquid dispensing apparatus, the cross-section of which is depicted in FIG. 1;

FIG. 2B is a magnified cross-sectional view of the assembly depicted in FIG. 2A;

FIG. 3 illustrates a magnified perspective view of a nozzle that may be utilized in an exemplary embodiment of a liquid dispensing apparatus;

FIG. 4 illustrates a second magnified perspective view of a nozzle that may be utilized in an exemplary embodiment of a liquid dispensing apparatus;

FIG. 5 is a magnified perspective view of the exterior of the barrel assembly depicted in FIG. 2A;

FIG. 6 is a further magnified perspective view of the exterior of the barrel assembly depicted in FIG. 5;

FIG. 7 is a front view of the exterior of the barrel assembly depicted in FIGS. 1, 2A, 2B, 5 and 6;

FIGS. 8A, 8B, and 8C depict views of a heater material that may be utilized in a liquid dispensing apparatus in accordance with an embodiment of the present invention.

FIG. 9 is a block diagram of switching and sensor mechanisms that may be incorporated in a liquid dispensing apparatus in accordance with the present invention;

FIG. 10 is a graph indicating the temperature regulation of a heating mechanism in the liquid dispensing apparatus in accordance with an embodiment of the present invention.

FIG. 11 is a schematic of a printed circuit board and associated circuitry for use in a liquid dispensing apparatus in accordance with an embodiment of the present invention;

FIG. 12 is a second schematic of a printed circuit board and associated circuitry for use in a liquid dispensing apparatus in accordance with an embodiment of the present invention; and

FIG. 13 illustrates an arrangement of a PTC heating element in a barrel assembly of a conventional glue gun.

### DETAILED DESCRIPTION OF THE PREFERRED EMBODIMENTS

The following discloses technology for enabling power-efficient and safe use of a portable electronic apparatus such as a glue gun. The tool is designed so as to allow for cordless operation, and the sizing, shape and composition of the heater and the motion sensing, temperature sensing and timing circuitry that are incorporated into the device maximize the amount of heat output to thereby minimize the energy required for powering the tool. Although it is envisioned that all or at least several of the embodiments discussed below are to be incorporated into an improved glue gun tool, the invention's scope is not so limited. Even taken singly, many of the improvements discussed below constitute significant advances in the field. Combining one or more of these improvements provides an extremely versatile and vastly improved tool.

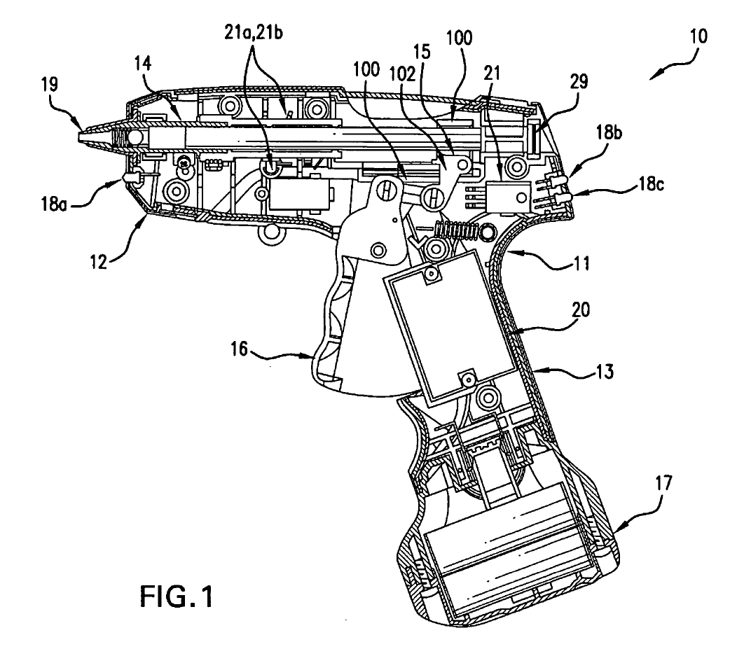

FIG. 1 is a side cross-sectional view of one exemplary embodiment of a portable electronic apparatus 10 constructed in accordance with aspects of the present invention. The apparatus is configured for applying heat to liquefy solid material, such as an adhesive (not shown), fed therein, and may be referred to as a glue dispensing apparatus. The apparatus includes a housing 11 constructed of two housing halves (one of which is shown in FIG. 1) preferably molded of heat resistant plastic. The housing includes a barrel portion 12 and a grip portion 13 that a user grasps and holds in one hand. The housing encases or has mounted thereto several components of the apparatus, including a heating assembly 14, an advancement mechanism 15, a trigger 16, a heat sink 21, and a power source 17. The apparatus is adapted to receive sticks of substantially solid material, such as adhesive, into one end of the housing, introduce the stick of adhesive to the heating assembly by the advancement mechanism actuated by the trigger, and to eject liquefied material from a nozzle 19 of the heating assembly at the other end of the housing. A clear window is provided in the housing atop the barrel portion to enable users to see whether a glue stick is inserted or how much of the glue stick already has been ejected as liquefied material from the nozzle 19.

As will be described further below in greater detail, the apparatus may additionally include one or more lights, such as light emitting diodes (LEDs) 18a, 18b, 18c for providing either alerts to the user or illumination of the object that is to receive the liquefied material. In further embodiments, the apparatus may include a printed circuit board 20 for providing heating control. In still further embodiments, the apparatus may additionally include one or more tilt sensors 21a, 21b.

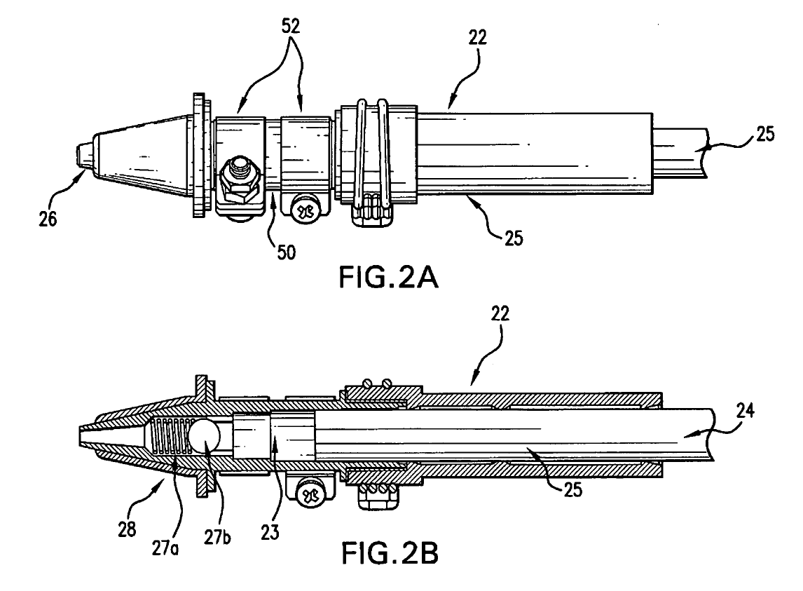

FIG. 2A depicts heating assembly 14 of FIG. 1 disposed in the barrel portion of the housing, and FIG. 2B is a cross-sectional view of the heating assembly. The heat body defines a heating chamber 22 that includes a longitudinal opening 23 therethrough, the rear end of which 24 defines an entrance for receiving a stick of adhesive 25, which may be advanced into the cooperatively shaped heating chamber by an advancement mechanism, as will be described in detail below. In a preferred embodiment, the heat body can accommodate 7.2 mm diameter all-purpose glue sticks in lengths greater than 100 mm. The heating chamber further defines a front end that forms an exit through which the melted glue is ejected. In the embodiment shown, integrally formed with the heat body is a nozzle 26 that extends outwardly from the front end of the barrel portion. The nozzle defines an opening fluidly communicating with the chamber so as to allow a stick of adhesive melted in the chamber to flow outwardly onto a workpiece. A nozzle guard or sleeve 28, may be utilized to cover the nozzle 26. The nozzle sleeve is fixed to the exterior of the nozzle adjacent the housing. The nozzle sleeve is made of silicon, flexible rubber, or other material that insulates the metallic nozzle to protect an operator from the heat that may flow through the nozzle from the heating elements.

As show in FIG. 2B, the nozzle may further include an anti-drip mechanism 27a, which may include a spring and a ball valve 27b, to prevent leakage of melted glue from the heating chamber when the apparatus is not in use. Incorporating a ball bearing stop mechanism substantially improves the performance of the device by eliminating or significantly reducing the unintended dripping of liquefied adhesive from the nozzle of the tool.

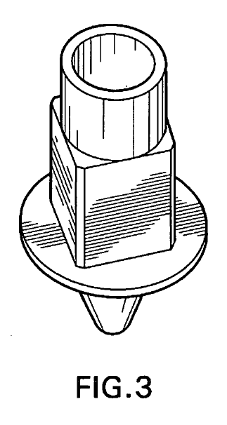

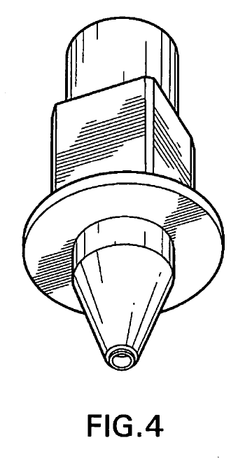

Perspective views of a nozzle that may be used with an apparatus in accordance with the present invention is provided in FIGS. 3 and 4. While the nozzle and heat body are shown as a one-piece construction, it will be appreciated that the nozzle may be constructed separate from the heat body. The heat body is preferably formed of a low density, high thermal conductive material, such as aluminum. For example, the material for the nozzle may be die cast Grade 356 or 360 aluminum.

The heat body and nozzle have been specifically designed to reduce thermal mass, while still providing users with sufficient durability and melted glue on demand. Particularly, aluminum is characterized by having a low density and high conductivity, which enables an aluminum nozzle to heat more quickly than those found in conventional glue guns.

Referring to FIGS. 2A and 2B, the heating assembly includes an elongated inlet sleeve 25. The inlet sleeve defines a flange portion fitted over the rear end of the heat body. The inlet sleeve has an interior passageway 23 that is disposed coaxially with the heating chamber, through which the stick of adhesive is introduced into the rear end of the heating chamber. As shown in FIG. 1, a guide collar 29 is disposed at the rear end of the barrel portion in coaxial relation to the inlet sleeve. The guide collar provides a guide opening coaxial with the heating chamber to guide the stick of adhesive and maintain the stick of adhesive in proper alignment with the heating chamber. The inlet sleeve and the guide collar are preferably made of silicone or silicon rubber. The inlet sleeve is preferably in sealing engagement with the heat body for preventing melted adhesive from escaping the heating chamber.

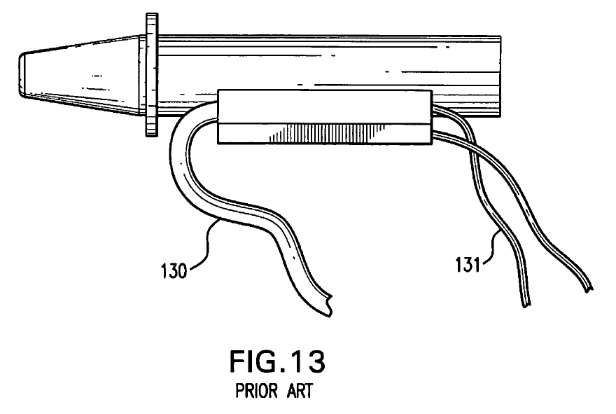

The heating mechanism for a glue gun in accordance with a preferred embodiment is now described. Conventional glue guns typically use positive temperature coefficient (PTC) heating elements for heating the barrel portion in the glue gun housing. Since PTC heating elements generally have an operating life of no more than approximately 1000 hours, most glue guns are discarded after a certain amount of usage. As shown in FIG. 13, the PTC heater in a typical glue gun is generally shaped as a box 130, such that only a single surface of the PTC heater contacts with only a small area on the surface of the cylindrically-shaped aluminum barrel 131. This arrangement usually is sufficient to generate adequate heat to melt the adhesive in the chamber, but there is significant heat loss from the sides that are not in contact with the barrel. Since a typical glue gun receives AC power from an electrical outlet, these inefficiencies in the design can be tolerated by applying high current to the heater.

In marked contrast with conventional glue gun tools, the heating assembly in an embodiment of the present invention includes one or more heating elements disposed in heat transfer relationship with the heat body, as described with reference to FIGS. 2A and 5-7. In the embodiment shown, a plurality of heating elements 50 are disposed at the forward end of the heat body, located closely to the nozzle 26. The heating elements are preferably secured to or maintained adjacent the heat body by either mechanical techniques, i.e., brackets, clamps, screws, etc. 52 or chemical techniques, i.e., epoxy, adhesives, to maintain a positive connection therebetween. However, other arrangements may be used. For example, the housing may be specifically designed with flanges, tabs, or other interior structure that retains the heating elements in contact with the heat body once assembled.

Thus, in a preferred embodiment, the heater 50 closely surrounds a small portion of the heat body proximate to the nozzle 26, thereby melting a volume of adhesive 25 near the exit point where glue is to be dispensed. In this manner, the size and shape of the heater are designed to require only a minimum amount of energy for dispensing liquefied adhesive. By reducing inefficiencies associated with conventional glue guns, performance can be maximized for low power, cordless operation.

In the embodiment shown, the heating elements are held in place via clamps 54 constructed of a metallic material, such as copper, or beryllium copper (BeCu) rings that act as electrical contacts. The clamps may also be used as power source connection terminals 52 for connecting the heating elements in electrical communication with the power source. Regardless of the coupling technique, the heating elements are electrically connected to the power source through circuitry such that electricity is routed through the heating elements or portions thereof.

The heating elements, due to their resistivity as will be described in detail below, heat to approximately 500 degrees F. when electricity is supplied thereto. In the embodiment shown in FIG. 1, power is supplied by a power source 17, such as a battery pack, selectively attached to the bottom of the grip portion by techniques known in the hand tool art.

The heating elements may be electrically isolated from the heat body. In several embodiments, this may be accomplished by disposing an electrical isolation barrier (not shown), such as a dielectric layer, between the heating elements and the heat body. The electrical isolation barrier may be formed by a polyimide substrate, preferably chemically secured via adhesive or the like to one of the surfaces. One such dielectric polyimide substrate that may be practiced with the present invention is sold as Kapton® tape, commercially available from DuPont®. In another embodiment, the outer surface of the heating elements or the heat body may be coated with a thin dielectric film, such as a phenolic coating. In yet another embodiment, the heat body may be constructed from anodized aluminum, the anodized surface of the heat body performing as a dielectric between the heat body and the heating elements. It will be appreciated that the thickness of the electrical isolation barrier should be kept to a minimum to both act as a electrical insulator but also to minimized the possible reduction of heat transfer between the heat body and the heating elements.

The heating element(s) is preferably formed of semi-conductive material, such as germanium, graphite, or silicon, or a material containing a semi-conductive material, such as germanium, graphite, or silicon. Preferably, a graphite foil is used, especially because this can be easily wrapped around the sleeve 25 and secured by clamps 54, thereby significantly reducing heat loss as compared with conventional heating systems. In an exemplary embodiment of the present invention, the heating element(s) has an electrical resistivity of approximately 250 micro-Ohm cm or greater. In other embodiments, the electrical resistivity is preferably approximately 750 micro-Ohm cm or greater, and more preferably approximately 1,500 micro-Ohm cm or greater. In yet other embodiments, the electrical resistivity of the heating elements is greater than approximately 3,000 micro-Ohm cm. In one embodiment, the heating elements may have a density in the range of approximately 1.0 to 2.2 g/cc, although other ranges are contemplated to be within the scope of the present invention.

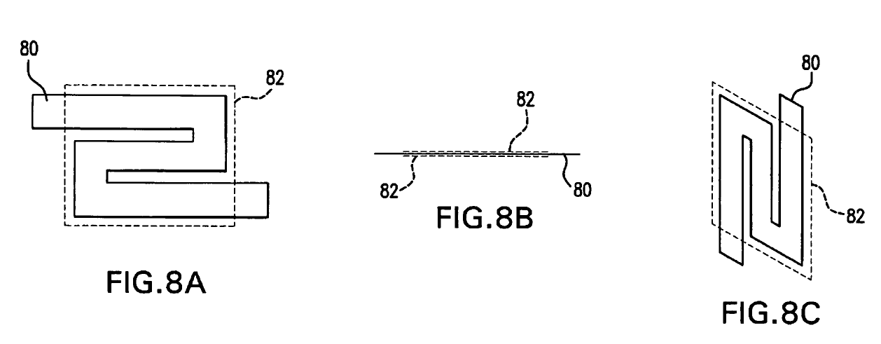

FIGS. 8A, 8B, and 8C illustrate several views of a serpentine-shaped configuration for graphite foil that is to be utilized as a heater for a glue gun in accordance with an exemplary embodiment of the present invention. The graphite foil 80 can be laminated between polymide sheets 82 (illustrated in FIGS. 8A and 8C on one side). The graphite foil is bendable so as to be formed and wrapped around the sleeve of the glue gun and fixed in place via clamps 54. As an alternative embodiment, several pieces of graphite foil can be separately wrapped around the sleeve.

To reduce heat loss and increase heat transfer efficiency, the area surrounding the heating elements may be thermally insulated. Various insulation techniques may be practiced with the present invention. For example, in one embodiment, a layer of insulation may envelope or overlay a portion of or substantially all of the exposed surfaces of the heating elements. Preferably, the thermal insulation layer can handle upper temperatures ranges around 500 degrees F. In one embodiment, the thermal insulation layer is constructed of commercially available calcium-magnesium-silicate; although other insulation layers may be used, such as aluminum-lined fiberglass.

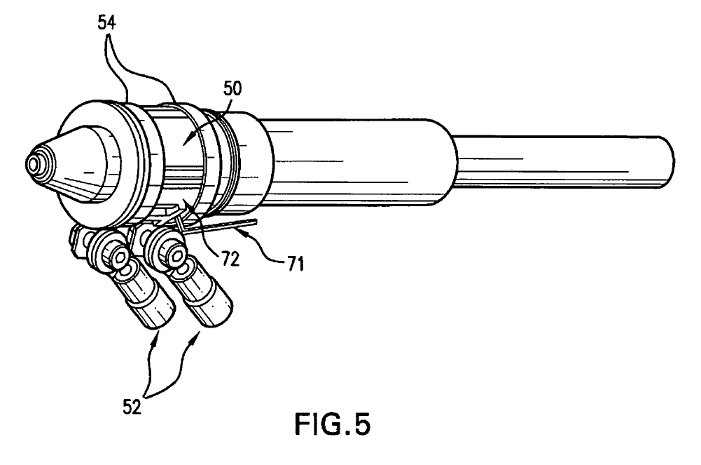

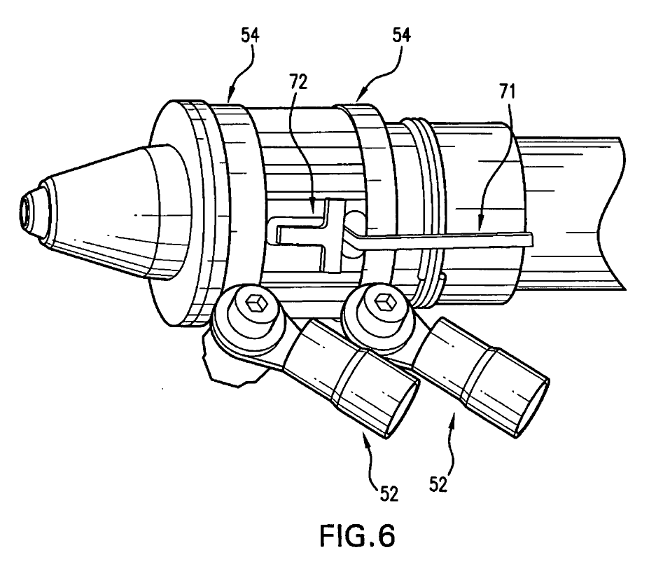

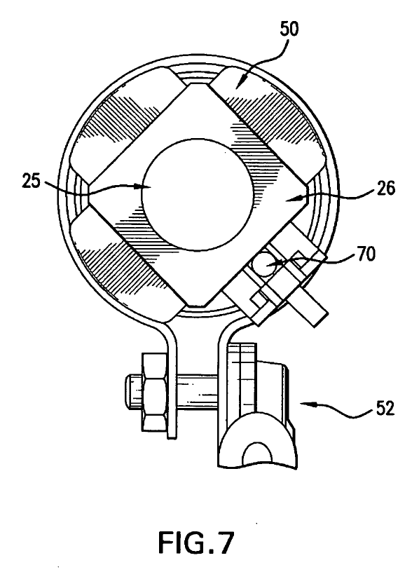

As shown in FIG. 7, the heating assembly further includes a temperature sensor 70. The temperature sensor is suitable mounted to the heat body and is capable of detecting the temperature of the heat body and outputting an appropriate signal indicative of the temperature of the heat body. FIG. 5 shows that the temperature sensor is attached via a clamp 72, and leads 71 connect it to a controller. In this embodiment, the temperature sensor may be a thermistor. FIG. 6 provides a magnified view of the clamp for the temperature sensor, along with the clamps for the heater assembly in close proximity. In FIG. 7, illustrating a front-facing view and arrangement of the nozzle 20, the temperature sensor 70 is shown proximate to the nozzle 26, surrounded by heater 50, with a glue stick 25 disposed therein.

Referring back to FIG. 1, the apparatus is manually operated and includes a trigger 16 that is pivotally connected to the housing. The trigger is configured to be conveniently actuatable by the index finger (or other fingers, singly or in combination) of the user's hand that is gripping the grip portion. A stabilizer (not shown) may be pivotally attached by pivot pins to the front portion of the housing. When the stabilizer pivots from an inoperative position to an operative position, the user can rest the apparatus on a flat surface such as a table or workbench such that the stabilizer and a resting surface of the grip portion cooperate to support the apparatus in an upright position. The stabilizer and the resting surface are configured in such a way that the apparatus may be supported by the two structures in a “resting position.” It can be appreciated that the stabilizer and resting surface may be altered or modified to adjust the distance between the nozzle and the workpiece in the resting position.

The advancement mechanism of the apparatus will now be described with continued reference to FIG. 1. The advancement mechanism functions to advance the stick of adhesive into the heating chamber upon actuation of the trigger. The advancement mechanism includes a carriage member 100 slidably mounted in the housing, behind the inlet sleeve. The carriage member is preferably molded of a single piece of a suitable material, such as plastic resistant to the temperatures employed. The carriage has a longitudinal bore, through which the stick of adhesive passes. The hole is preferably sized somewhat larger than the outside diameter of the stick of adhesive to avoid jamming and to allow easy insertion. The carriage is preferably provided with longitudinal rails 101 on each side that fit into corresponding slots on the housing, for guiding the path of travel of the carriage. The carriage has a transverse opening in communication with the longitudinal opening through which a gripper member 102 passes into. The gripper member includes a head portion and a lower portion defining a somewhat transverse lever. The gripper member is pivotally mounted to the carriage at the head portion. The head portion further includes a protrusion or tooth for gripping the glue stick when actuated by the trigger. The gripper member is coupled to the trigger through appropriate linkage. In the embodiment shown, the linkage includes a linkage member pivotally attached to the lower portion of the gripper and pivotally attached to the upper portion of the trigger. When assembled, the linkage member is disposed somewhat parallel to the glue stick.

In use, the squeezing action of the trigger causes the carriage to advance forwardly, thereby advancing the stick of adhesive into the heating chamber. A spring is secured from the trigger to a trigger spring attachment point for returning the trigger to an initial position upon release of pressure imparted on the trigger.

It will be appreciated that the apparatus may include other components and/or features. For example, the apparatus may include a light 18a disposed on the barrel portion of the apparatus for emitting light onto the area of discharged adhesive.

As described above, conventional glue guns are typically powered by plugging a cord into an AC electrical outlet. For some applications, this provides satisfactory results. However, by minimizing power requirements, certain embodiments in accordance with the invention allow for cordless operation. This allows the glue gun tool to be utilized outdoors and in other areas where an electrical outlet is not nearby. Cordless operation also allows for greater maneuverability, since the user's range of motion is not hampered by an electrical cord.

As was discussed above, the apparatus includes a power source, which in the embodiment shown, may be selectively attached to the grip portion. The power source 17 may be a battery or battery pack comprised of one or more rechargeable batteries or battery cells, for example, Nickel Cadmium (NiCd), Nickel Metal Hydride (NiMH), Lithium, or Lithium ion batteries, just to name a few. Particularly, a pack of four AA NiMH rechargeable batteries provides approximately 20 Watts of power to the semiconductive heating elements. While rechargeable batteries or battery cells are preferred, non-rechargeable batteries or other power storage sources may be used. Alternatively, other power sources, such as low voltage provided from a line voltage through a transformer or a low-voltage power source provided via a power providing device, may be practiced with the present invention. In one embodiment, the power source includes a number of Nickel Metal Hydride (NiMH) batteries encased within a power source housing detachably coupled to the grip portion to provide a nominal voltage of between approximately 3.0 and 6.0 volts.

Other embodiments may use a power source having lower or higher voltages, if desired. However, it can be recognized as a particular advantage for certain embodiments of the present invention that minimizing heat loss as described above allows for the use of low power battery cells, which tend to be lighter and less expensive. The innovative selection and design of the heating assembly and other associated power-saving circuitry allows further provides for long battery life with low battery cells before the cells must be recharged or discarded.

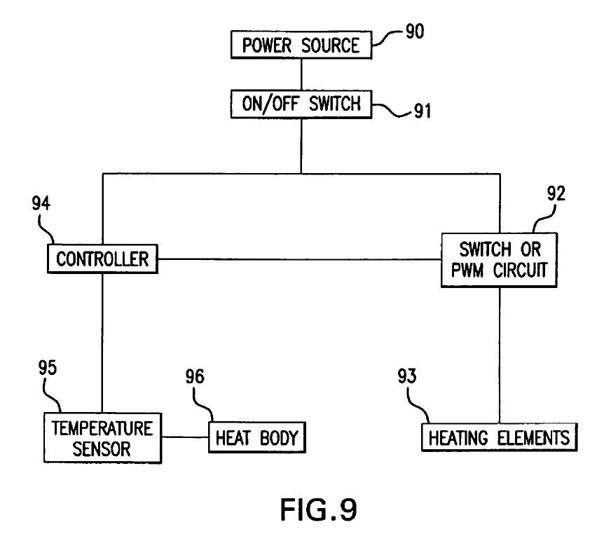

FIG. 9 is a block diagram of one exemplary embodiment of a system that may be practiced with the present invention. The system includes the heating elements 93 electrically connected to the power storage source 90 through an on/off switch 91. The system also includes a controller 94, that outputs control signals to a controllable switch 92 to either 1) close the switch so that electricity may flow from the power source 90 to the heating elements 93 or 2) open the switch so that electricity is prohibited from flowing to the heating elements 93. The controller may include a logic system for determining the operation of switch and other components hereinafter described. It will be appreciated by one skilled in the art that the logic may be implemented in a variety of configurations, including but not limited to, analog circuitry, digital circuitry, processing units, and the like. Alternatively, the controllable switch may be replaced by a suitably configured pulsing circuit, such as a pulse width modulation (PWM) circuit, for modulating the power supplied to the heating elements. It will be appreciated that the pulsing circuit may be arranged by one of ordinary skill in the art, and will not be described in detail here.

In one embodiment, the controller may include a processing unit, a memory, and input/output (I/O) circuitry connected in a conventional manner. The memory may include random access memory (RAM), read only memory (ROM), or any other type of digital data storage means. The I/O circuitry may include conventional buffers, drivers, relays and the like, for sending device appropriate signals to the switch or a pulse width modulation (PWM) circuit and to other components hereinafter described. A particular embodiment in which the controller is implemented using an integrated circuit is described below.

The controller 94 is further electrically connected to the temperature sensor 95 for receiving suitable signals corresponding to the temperature of the heat body. The temperature sensor may be a thermocouple or thermister connected to the heat body 96 in a conventional manner. In use, the controller monitors the temperature of the heat body by receiving the output of the temperature sensor through an appropriate sensor specific interface, and controls the operation of the switch or PWM circuit for maintaining the temperature of the heat body above or between the desired temperature range. It will be appreciated that the controller may be programmed to continuously or selectively alter the duty cycle of the PWM circuit when maintaining the temperature of the heated heat body within a desired range.

For example, during the operation of the apparatus, once the on/off switch is activated to the “on” position, electricity is provided to the components of the apparatus and routed to the heating elements. The temperature sensor continuously senses the temperature of the heat body and transmits a signal to the controller indicative of the heat body temperature. If the controller determines that the heat body temperature has dropped below the preselected threshold temperature based on the sensor output, the controller transmits a device appropriate signal to the controllable switch or PWM circuit, thereby supplying electricity to the heating elements.

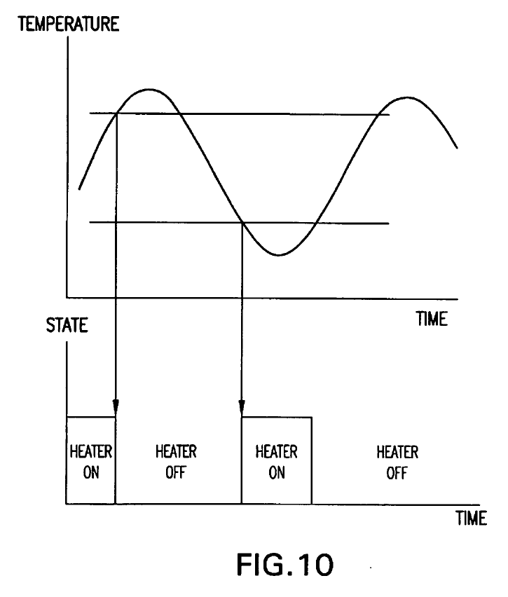

FIG. 10 is a graph illustrating how the heater responds to the temperature sensor, in accordance with an exemplary embodiment of the present invention. As can be seen, the temperature of the nozzle varies over time as the heater is applied and withdrawn. As heat is applied, the temperature of the nozzle continues to rise, as detected by the temperature sensor. The temperature sensor continues to provide readings to a controller (or alternatively, a comparator that can be implemented in analog circuitry). Once the temperature rises above a high temperature threshold, the state changes to turn off the heater, as shown in the state diagram. Due to hysteresis, the temperature continues to rise, but then falls. Once the temperature falls below a low temperature threshold, the controller sends a signal for the heater to be turned on once again. In a similar manner, the temperature continues to fall, but then rises. This process is continued to regulate the temperature to be substantially between the upper and lower threshold.

In accordance with another aspect of the present invention, the apparatus optionally may include a power save mode. Returning to the description of the apparatus above, when the trigger is pulled to advance the stick of adhesive into the heating chamber, a timing signal is generated by a trigger switch and transmitted to the controller. The controller receives the timing signal and starts a clock. The controller monitors the clock until a second timing signal is received from the trigger switch, which results in resetting the clock. If, however, the second timing signal is not received before a preselected time period, for example, five minutes, the controller automatically shuts off power to the heating elements for enhancing power source life. A status indicator, such as a light 18b or 18c in FIG. 1, may be provided to indicate to the user when the apparatus in the power save mode.

In accordance with another aspect of the present invention, the apparatus may include a low power detection circuit. The circuit can be utilized to detect a low power condition, an operational voltage drop by the electrical power source, or current flowing through the heating elements. Generally, the circuit functions to indicate by way of a light disposed on the apparatus, a low power condition of the power source or an operational drop in voltage. This is accomplished by comparing the voltage produced by the power source (across the source) during use, hereinafter referred to as the operation voltage, with a preselected reference voltage. The reference voltage, if the power source is a battery, may be selected between the voltage of a fully charged battery and the voltage of a partially or fully discharged battery. If the operational voltage of the power source drops below the reference voltage at any time during use, then the circuit is configured to illuminate the light. It will be appreciated that when the power source is a battery, the operational voltage varies upon usage of the device. In one embodiment, the controller may be used to internally generate the reference voltage, compare the reference voltage to the operational voltage of the power source, and based on the comparison, permit the light to illuminate.

During use (e.g. when the on/off switch is activated), the operational voltage from the power source is supplied to controller. The controller, which includes components that generate a reference voltage, compares the operational voltage supplied to the controller with the reference voltage generated by the controller. If the reference voltage is greater than the operational voltage, the controller outputs an appropriate signal to deliver current to the light, and as a result, illuminates the light.

For example, when current is routed through the resistive heating elements, the load on the power source by the resistivity of the heating elements, causes the voltage of the power source to drop. It will be appreciated that the reference voltage may be selected such that if current is being supplied to the heating elements, the operational voltage measured by the controller will be lower than the reference voltage. As a result, the light 18a in FIG. 1 will illuminate, thereby giving the user a visible indication that power is being supplied to the heating elements, and thus, to the heating chamber to melt the stick of adhesive.

Additionally, it will be appreciated that in one embodiment, the reference voltage may be selected so that a low power condition of the power source (e.g., a battery that is substantially discharged) will cause the light to illuminate. Thus, in accordance with another aspect of the present invention, the light may be utilized to indicate when the power source is in need of replacement or a recharge. It will also be apparent that a second reference voltage may be chosen that corresponds to a substantially discharged power source. This may be beneficial since the controller may be programmed or configured to shut off power to the heating element and associated apparatus components when the operational voltage drops below the second reference voltage, thereby protecting power sources, such as rechargeable batteries, that are sensitive to complete discharge.

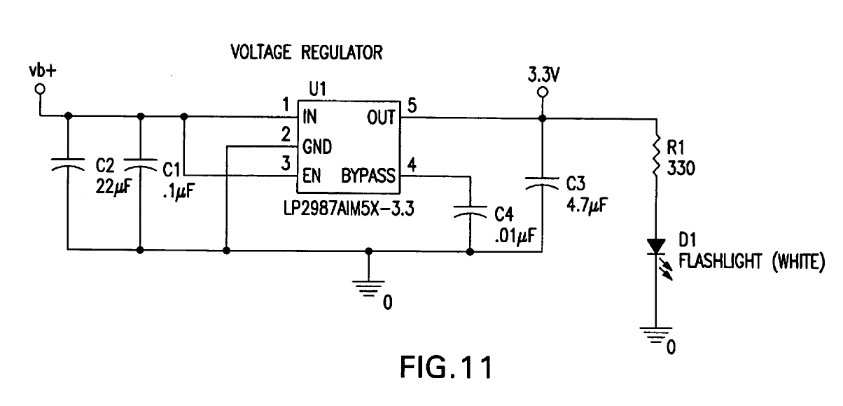

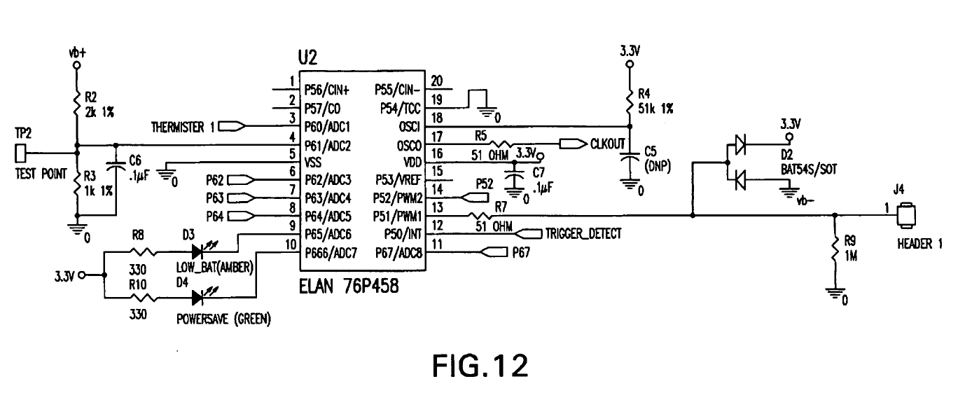

FIGS. 11-12 include possible pin-out diagrams and circuitry for connecting the controller in accordance with a preferred embodiment of the present invention. FIG. 11 illustrates possible connections using chip LP2987AIM5X-3.3. In this figure, “vb+” is connected to the battery power source, and provides an output constant voltage (3V) as required by the controller chip. “D1” is a white LED for illuminating the workpiece, as described above.

FIG. 12 illustrates possible connections using chip ELAN 78P458 as the controller. R2 and R3 are part of a voltage divider for dividing the battery voltage, where pin 4 detects a low battery. Pin 9 connects to D3 to generate a light indicating a low battery, and pin 10 generates a light D4 to indicate that a power save operation occurs. The negative terminal of the battery is connected to pin 5. Pin 18 is connected to a RC coupler (R4 and C5) for generating the clock. Pins 11 and 12 connect to trigger_detect1 and trigger_detect2, respectively, for a tilt sensor, as described above. Pin 13 is output to a FET to turn on and off the heater. Finally, pin 3 is connected to thermistor1 for measuring the temperature of the nozzle to control when to turn on and off the heater.

It will be appreciated that other status indicators other than the lights may be utilized by the apparatus. For example, a tone-producing mechanism (not shown) that creates an auditory response when a low power condition or a voltage drop is detected may be implemented with the apparatus.

On the other hand, if the reference voltage is less than the operational voltage, the light does not illuminate. This may occur when power is not being supplied to the heating elements and the power source has a sufficient charge.

While the preferred embodiment of the invention has been illustrated and described, it will be appreciated that various changes can be made therein without departing from the spirit and scope of the invention. For example, while a cordless apparatus has been shown and described, it will be appreciated that the apparatus may include a power cord operably connected to the components of the apparatus through appropriate circuitry known to those skilled in the art so that the apparatus may be powered solely by an AC power source, such as a common household power outlet. It will be appreciated that a step down transformer and/or rectifier circuitry may be employed to operate the components of the apparatus from power being supplied from the power outlet. Alternatively, the apparatus may include a power cord operably connected to the components of the apparatus through appropriate circuitry known to those skilled in the art so that the apparatus may be powered solely by an exterior DC power source.

Other embodiments, extensions, and modifications of the ideas presented above are comprehended and should be within the reach of one versed in the art upon reviewing the present disclosure. Accordingly, the scope of the present invention in its various aspects should not be limited by the examples presented above. The individual aspects of the present invention, and the entirety of the invention should be regarded so as to allow for such design modifications and future developments within the scope of the present disclosure.

1. An apparatus for dispensing liquefied adhesive, comprising:
a chamber having an opening at one end thereof for allowing a supply of solidified adhesive to be inserted therein;
a nozzle fluidly communicated with the chamber, configured for allowing molten adhesive to flow therethrough;
a heater associated with the chamber and operable to apply heat to the chamber sufficient to melt a portion of a solidified adhesive inserted in the chamber;
wherein the heater is comprised of a semiconductive material configured to substantially surround a circumference of a longitudinal portion of the chamber.

2. The apparatus of claim 1, wherein the heater is comprised of a thin, flexible semi-conductive heating element.

3. The apparatus of claim 2, wherein the heater is comprised of graphite foil.

4. The apparatus of claim 1, further comprising at least one clamp in electrical communication with the heater, wherein the clamp is further connected to a power source.

5. The apparatus of claim 1, wherein the nozzle is made substantially of aluminum.

6. An apparatus for dispensing liquefied adhesive, comprising:
a chamber having an opening at one end thereof for allowing a supply of solidified adhesive to be inserted therein;
a nozzle fluidly communicated with the chamber, configured for allowing molten adhesive to flow therethrough;
a heater associated with the chamber and operable to apply heat to the chamber sufficient to melt a portion of a solidified adhesive inserted in the chamber;
a power source in electrical communication with the heater that is capable of providing for cordless operation; and
a temperature sensor for detecting the temperature of the chamber, wherein output of the sensor is provided as an input to circuitry that that turns off electrical power to the heater when the temperature of the chamber reaches a threshold amount.

7. The apparatus of claim 6, wherein the power source is comprised of one or more batteries.

8. The apparatus of claim 6, wherein the temperature sensor is a thermistor.

9. The apparatus of claim 6, wherein the circuitry is a controller that determines whether the temperature of the chamber has reached the threshold.

10. The apparatus of claim 6, wherein the circuitry also turns on electrical power to the heater when the temperature of the chamber falls below a threshold amount.
